(19) United States
(12) Patent Application Publication
(10) Pub. No.: US 2006/0271756 A1
(43) Pub. Date: Nov. 30, 2006

(54) Apparatus and method for reducing delay in operating time caused during DRAM hidden refresh operation

(76) Inventors: Suk-Soo Pyo, Busan (KR); Hyun-Taek Jung, Seoul (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/344,567

(22) Filed: Feb. 1, 2006

(30) Foreign Application Priority Data
May 27, 2005 (KR) 10-2005-0044746

(51) Int. Cl. G06F 13/00

(52) U.S. Cl. 711/167

(57) ABSTRACT

An arrangement for reducing delay in an operating time of a memory device caused during a DRAM hidden refresh operation, includes a memory bank having memory cells, first and second data buses connected to the memory bank, a cache memory connected to the second data bus, and a latch connected to the second data bus. In response to a memory write command, the second data bus transmits data read from the cache memory to the latch in an i^{th} period of time (i is a natural number), and the data read from the latch to the memory bank in an (i+1)^{th} period of time. In response to a cache write command, the second data bus transmits data read from the memory bank to the latch in an i^{th} period of time, and the data read from the latch to the cache memory in an (i+1)^{th} period of time.

### CROSS-REFERENCE TO RELATED PATENT APPLICATIONS

This application claims the priority of Korean Patent Application No. 10-2005-0044746, filed on May 27, 2005, in the Korean Intellectual Property Office, the disclosure of which is hereby incorporated by reference herein in its entirety for all purposes as if fully set forth herein.

### BACKGROUND OF THE INVENTION

1. Field of the Invention

The present invention relates to a semiconductor device and a data transmission method, and more particularly, to a semiconductor device capable of performing a dynamic random access memory (DRAM) hidden refresh operation using a latch and a method of transmitting data in the semiconductor device.

2. Description of the Related Art

Each dynamic random access memory (DRAM) cell that uses one capacitor and one transistor as a unit storage device must be refreshed periodically to retain charges (or data) stored in the capacitor. Such a refresh operation causes a delay in a data access time of a semiconductor device with DRAM cells.

To reduce the delay in the data access time due to the refresh operation, the semiconductor device with DRAM cells performs a hidden refresh operation. In the hidden refresh operation, the refresh operation is performed on one of a plurality of memory banks simultaneously with normal data access operations, e.g., write/read operations, performed on the other memory banks.

FIG. 1A is a block diagram, and FIG. 1B is a timing diagram of a conventional semiconductor device 1 capable of performing a DRAM hidden refresh operation using a cache memory.

The hidden refresh operation is divided into a write-forward operation and a write-back operation. In the write-forward operation, after a pair of bit lines are equalized and a word line WL of a corresponding memory cell is activated, data stored in a memory bank 3 is moved to a cache memory 7 using a driver 5 for a period of time T, and the data stored in cache memory 7 is used when an external device (not shown) accesses memory bank 3.

In the write-back operation, the data stored in cache memory 7 is moved to memory bank 3 using driver 5 for the period of time T so as to store new data in cache memory 7.

Semiconductor device 1 writes the data read from cache memory 7 to corresponding memory bank 3 within the period of time T. Thus, since the data read from cache memory 7 must be written to memory bank 3 within the period of time T, a delay in the operating time (e.g., data access time) of semiconductor device 1 is unavoidable. A delay in the operating time is a fatal defect of the hidden refresh operation intended for a high-speed operation of semiconductor device 1.

Accordingly, it would be desirable to provide an apparatus and method for reducing a delay in an operating time in a semiconductor device capable of performing a DRAM hidden refresh operation.

### SUMMARY OF THE INVENTION

According to one aspect of the present invention, there is provided a semiconductor device including a memory bank with a plurality of memory cells, a first data bus connected to the memory bank and via which data to be input to or output from the memory bank is transmitted based on a memory access command that accesses the memory bank, a second data bus connected to the memory bank, a cache memory connected to the second data bus, and a latch connected to the second data bus.

In response to a memory write command that stores first data read from the cache memory in the memory bank, the second data bus is adapted to transmit the first data read from the cache memory to a latch in an i^{th} period of time (where i is a natural number), and to transmit the first data read from the latch to the memory bank in an (i+1)^{th} period of time.

Alternatively, in response to a cache write command that stores first data read from the memory bank to the cache memory, the second data bus is adapted to transmit the first data read from the memory bank to a latch in an i^{th} period of time, and to transmit the first data read from the latch to the cache memory in an (i+1)^{th} period of time.

According to another aspect of the present invention, there is provided a semiconductor device including a plurality of memory banks, each memory bank having a plurality of memory cells; a cache memory having a plurality of cache memory cells; a latch adapted to store data read from either one of the plurality of the memory banks or the cache memory; and a data bus connected to each memory bank, to the cache memory, and to the latch.

According to yet another aspect of the present invention, there is provided a method of transmitting data, such as a memory write command or a cache write command, the method comprising receiving a data transmission command; and in response to the data transmission command, transmitting data stored in a first data storage device to a latch via a data bus in an i^{th} period of time, and transmitting data stored in the latch to a second data storage device via the data bus in an (i+1)^{th} period of time. Accordingly, two cycles of time are required to move the data stored in the first data storage unit to the second data storage unit.

The first data storage device may be a memory bank and the second data storage device may be a cache memory, and vice versa.

### BRIEF DESCRIPTION OF THE DRAWINGS

The above and other aspects and advantages of the present invention will become more apparent by describing in detail exemplary embodiments thereof with reference to the attached drawings in which:

FIG. 1A is a block diagram of a conventional semiconductor capable of performing a dynamic random access memory (DRAM) hidden refresh operation using a cache memory. FIG. 1B is a timing diagram of a conventional semiconductor device capable of performing a dynamic random access memory (DRAM) hidden refresh operation using a cache memory.

FIG. 2 is a conceptual diagram illustrating the construction of a semiconductor device on which the DRAM hidden refresh operation is performed using a latch.

FIG. 3 is a block diagram of one embodiment of a semiconductor device realized based on the conceptual diagram of FIG. 2.

FIG. 4 is a block diagram of another embodiment of a semiconductor device realized based on the conceptual diagram of FIG. 2.

FIGS. 5A through 5C are conceptual diagrams illustrating a memory write operation performed by an embodiment of semiconductor device.

FIGS. 6A through 6C are conceptual diagrams illustrating the operation of an embodiment of a semiconductor device when there is a collision between a memory write command and a cache refresh command.

FIGS. 7A through 7C are conceptual diagrams illustrating the operation of an embodiment of a semiconductor memory device when a memory write command and a memory access command are simultaneously performed.

FIGS. 8A and 8B are conceptual diagrams illustrating the operation of an embodiment of a semiconductor device when a memory write command and a memory access command are simultaneously performed on the same memory bank.

FIGS. 9A through 9C are conceptual diagrams illustrating a cache write command performed by one embodiment of a semiconductor device.

FIGS. 10A through 10C are conceptual diagrams illustrating cache write commands, which are generated sequentially, to be performed by one embodiment of a semiconductor device.

FIGS. 11A and 11B are conceptual diagrams illustrating the operation of one of a semiconductor device when a cache write command and a memory access command are simultaneously performed, according to an embodiment of the present invention.

FIGS. 12A and 12B are conceptual diagrams illustrating the operation of one embodiment of a semiconductor memory when a memory write command is generated after a cache write command.

FIGS. 13A through 13C are conceptual diagrams illustrating the operation of one embodiment of a semiconductor device when a cache write command and a cache access command are simultaneously performed.

FIG. 14 is a timing diagram of an operating time of a semiconductor device such as that shown in FIGS. 2, 3, and 4.

### DETAILED DESCRIPTION

Hereinafter, exemplary embodiments of the present invention will be described in detail with reference to the accompanying drawings. Like reference numerals denote like elements in the drawings.

FIG. 2 is a conceptual diagram of an embodiment of a semiconductor device 200 on which a dynamic random access memory (DRAM) hidden refresh operation is performed using a latch 250. Referring to FIG. 2, semiconductor device 200, such as an integrated circuit or a chip, includes a first data bus 210-1, a second data bus 210-2, a plurality of memory banks 2201, 2202, 2203, 2204, . . . , 220n (n is a natural number), a controller 230, a latch 250, and a cache memory 270. Beneficially, latch 250 is separate from cache memory 270 and the memory banks 2201, 2202, 2203, 2204, . . . , 220n.

Each of memory banks 2201, 2202, 2203, 2204, . . . , 220n includes a plurality of data storage units, e.g., DRAM cells, that store data. Semiconductor device 200 is embodied to have a dual input/output (I/O) bus structure with first and second data buses 210-1 and 210-2.

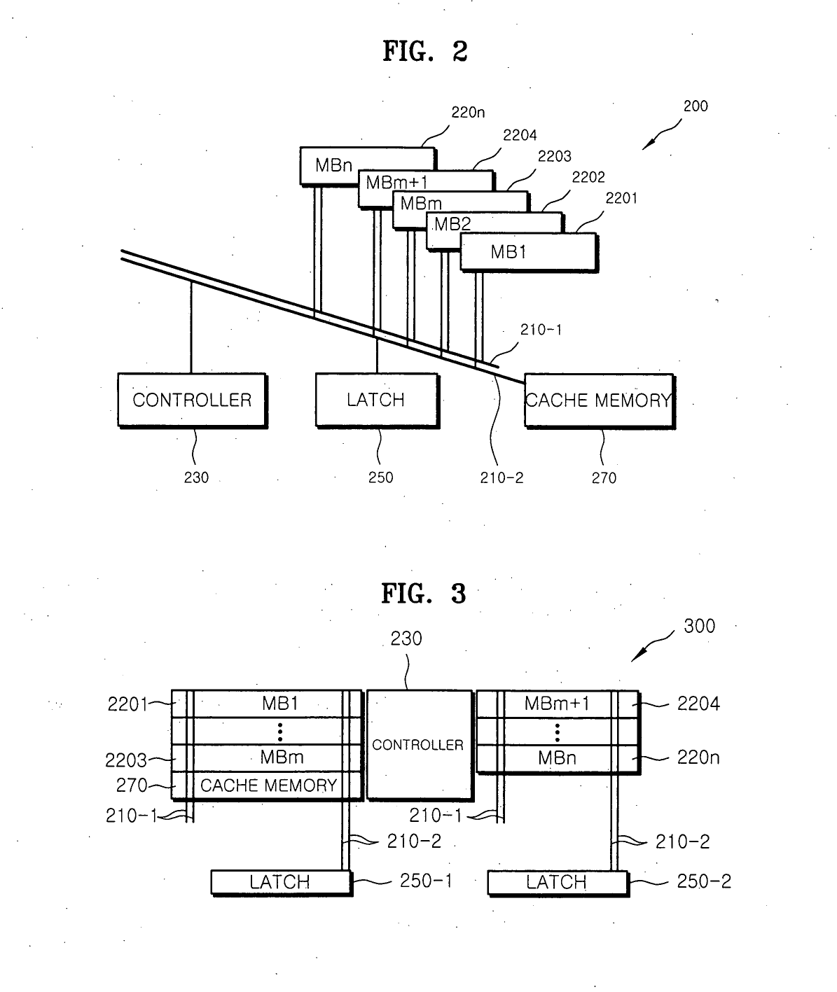

FIG. 3 is a block diagram of one embodiment of a semiconductor device 300 realized based on the conceptual diagram of FIG. 2. Semiconductor device 300 includes the plurality of memory banks 2201, . . . , 2203, 2204, . . . , 220n (n is a natural number), first data bus 210-1, second data bus 210-2, controller 230, latches 250-1 and 250-2, and cache memory 270.

Each of memory banks 2201, . . . , 2203 exchanges data with an external device (not shown) via first data bus 210-1 in response to a corresponding memory access command, e.g., a write command or a read command.

Memory banks 2201, . . . , 2203, the latch 250-1, and cache memory 270 are connected to second data bus 210-2, and memory banks 2204, . . . , 220n and latch 250-2 are also connected to the second data bus 210-2. Each of memory banks 2201, . . . , 2203, latch 250-1, and cache memory 270 exchange data via second data bus 210-2. Beneficially, latches 250-1 and 250-2 are each separate from cache memory 270 and the memory banks 2201, 2202, 2203, 2204, . . . , 220n.

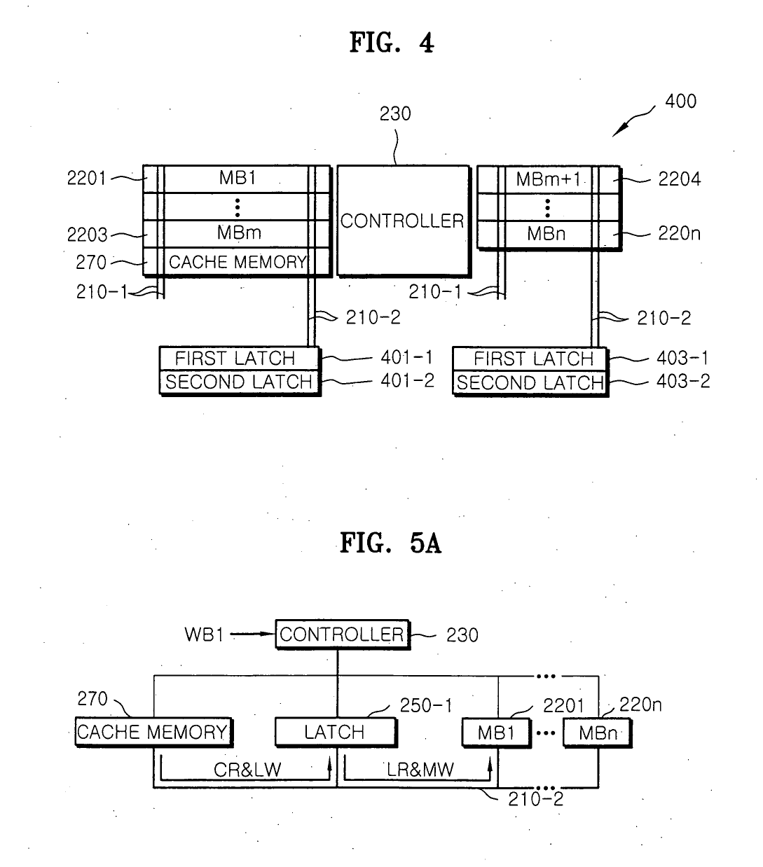

FIG. 4 is a block diagram of another embodiment of a semiconductor device 400 realized based on the conceptual diagram of FIG. 2. The semiconductor device 400 includes the plurality of memory banks 2201, . . . , 2203, 2204, . . . , 220n (where n is a natural number), first data bus 210-1, second data bus 210-2, controller 230, cache memory 270, first latches 401-1 and 403-1, and second latches 401-2 and 403-2. Beneficially, latches 401-1, 401-2, 403-1 and 403-2 are each separate from cache memory 270 and the memory banks 2201, 2202, 2203, 2204, . . . , 220n.

Each of memory banks 2201, . . . , 2203, 2204, . . . , 220n exchanges data with a corresponding external device (not shown) via the corresponding first data bus 210-1 in response to a corresponding memory access command, e.g., a write command or a read command.

Each of memory banks 2201, . . . , 2203, 2204, . . . , 220n, cache memory 270, and first and second latches 401-1 and 401-2 are connected to a corresponding second data bus 210-2. Each of memory banks 2201, . . . , 2203, 2204, . . . , 220n, cache memory 270, first and second latches 401-1, and 401-2 exchange data via the corresponding second data bus 210-2.

Each of first latches 401-1 and 403-1 latches data to be input or output via second data bus 210-2 during a cache (or cache memory) write operation which is also referred to as a “write-forward operation.” That is, each of first latches 401-1 and 403-1 stores data to be read from a corresponding memory bank 2201, . . . , 2203, 2204, . . . , or 220n and written to cache memory 270.

Each of second latches 401-2 and 403-2 stores data to be input or output the second data bus 210-2 during a memory write operation which is also referred to as a “write-back operation.” That is, each of second latches 401-2 and 403-2 stores data to be read from cache memory 270 and written to a corresponding memory bank 2201, . . . , 2203, 2204, . . . , or 220n.

Controller 230 controls the operations of memory banks 2201, 2203, 2204, and 220n, cache memory 270, first latches 401-1 and 403-1, and second latches 401-2 and 403-2 so as to perform the cache write operation in response to a cache write command, the memory write operation in response to a memory write command, and a memory access operation in response to a memory access command.

In the memory access operation, the external device writes predetermined data to a memory bank selected by a corresponding address, or reads predetermined data from a corresponding memory bank, in response to the memory access command.

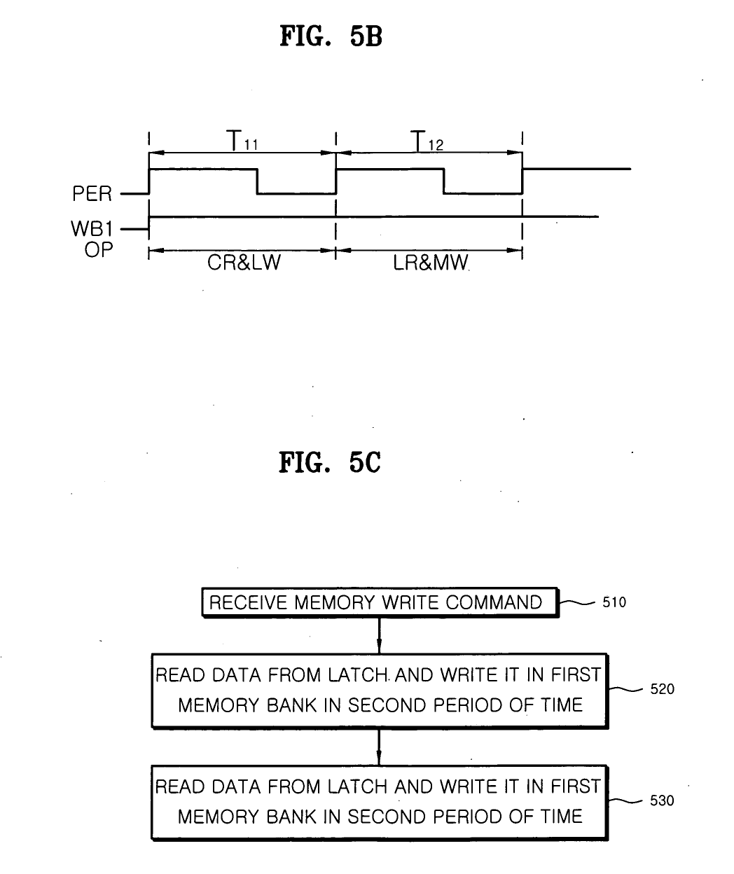

FIGS. 5A through 5C are conceptual diagrams illustrating a memory write operation performed by one embodiment of a semiconductor device. When receiving a memory write command WB1 that moves data stored in cache memory 270 to first memory bank 2201 so as to store new data in cache memory 270 (step 510), controller 230 controls the data to be read from cache memory 270 (cache read: CR) and written in latch 250-1 (latch write: LW) in a first period of time T₁₁ (step 520).

In a second period of time T₁₂, the controller 230 controls the data to be read from latch 250-1 (latch read: LR) and written in first memory bank 2201 (memory write: MW) (step 530). The two periods of time T₁₁+T₁₂ are required to complete the memory write operation.

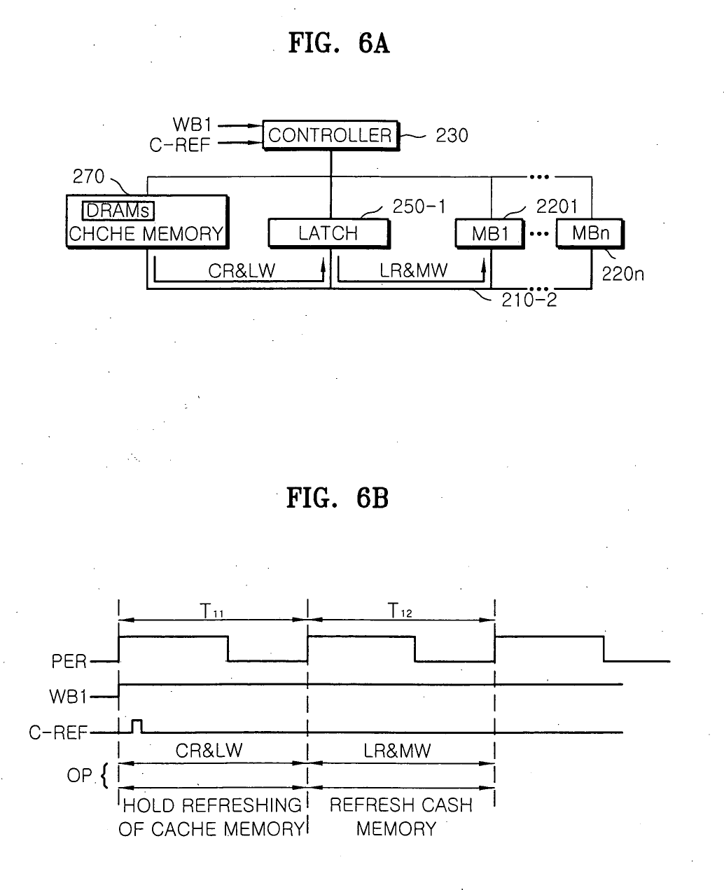

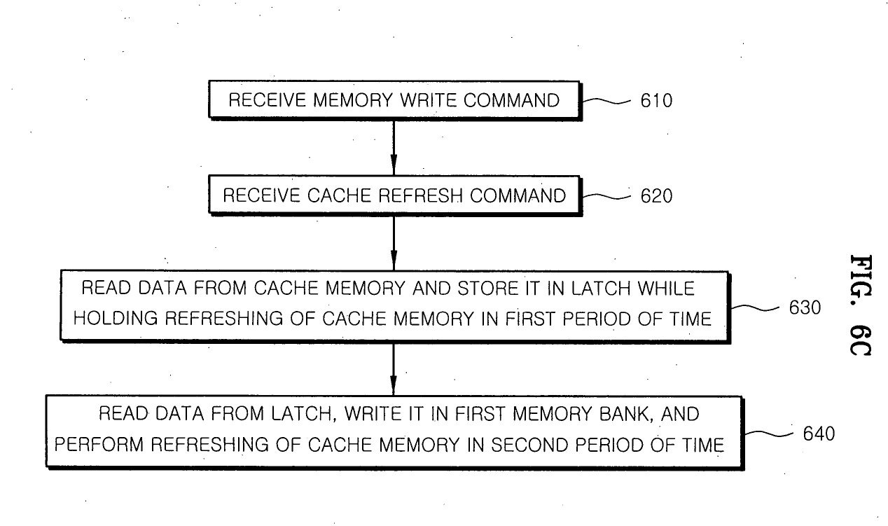

FIGS. 6A through 6C are conceptual diagrams illustrating the operation of one embodiment of a semiconductor device when there is a collision between a memory write command WB1 and a cache refresh (memory) command C-REF.

When cache memory 270 includes DRAM cells, the DRAM cells are refreshed in response to the cache refresh command C-REF.

After the memory write command WB1 is input to controller 230 (step 610), when the cache refresh command C-REF is input to controller 230 during a memory write operation, i.e., when there is a collision between the memory write command WB1 and the cache refresh command C-REF (step 620), controller 230 controls data to be read from cache memory 270 (CR) and stored in latch 250-1 (LW) via the second data bus 210-2, and holds a refresh operation for cache memory 270 in a first period of time T₁₁ in response to the memory write command WB1 (step 630).

In a second period of time T₁₂, controller 230 controls the data to be read from latch 250-1 (LR) and written in first memory bank 2201 (MW) via second data bus 210-2, and performs the refresh operation in cache memory 270, in response to the memory write command WB1 (step 640).

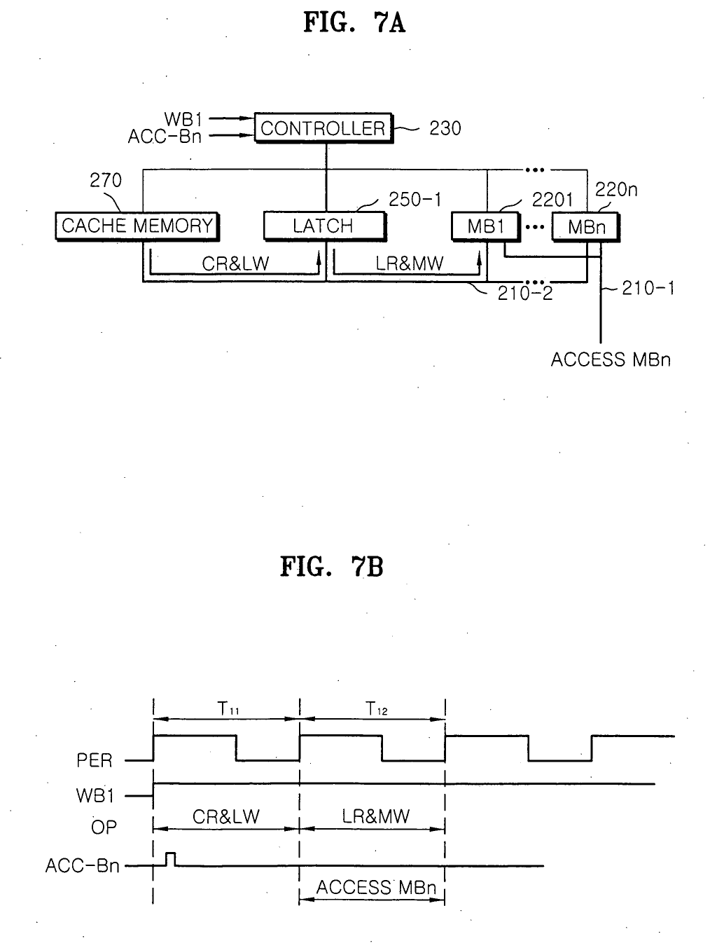

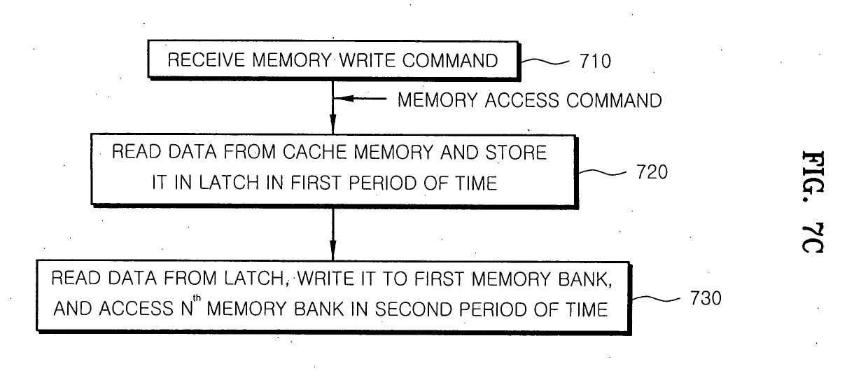

FIGS. 7A through 7C are conceptual diagrams illustrating the operation of one embodiment of a semiconductor memory device when a memory write command WB1 and a memory access command ACC-Bn are simultaneously performed.

After the memory write command WB1 is input to controller 230 (step 710), when the memory access command ACC_Bn that accesses n^{th} memory bank 220n is input to controller 230, controller 230 controls predetermined data to be read from cache memory 270 and stored in latch 250-1 via second data bus 210-2 in a first period of time T₁₁ (step 720).

In a second period of time T₁₂, controller 230 controls the data to be read from latch 250-1 and written in first memory bank 2201 via second data bus (210-2), and controls an external device to access the n^{th} memory bank 220n via the first data bus 210-1 (step 730).

That is, since the semiconductor device has a dual input/output bus structure, it can simultaneously perform the memory access command ACC_Bn and the memory write command WB1 via corresponding data buses 210-1 and 210-2.

Also, controller 230 controls cache memory 270 to retain the data output from cache memory 270 to latch 250-1 until a memory write operation is completed. For instance, cache memory 270 stores first data until the first data is completely moved to first memory bank 2201.

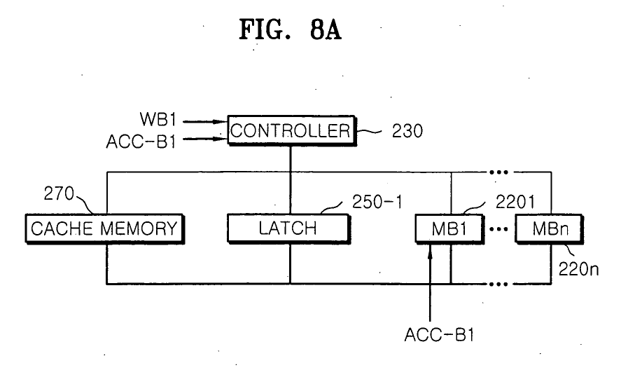

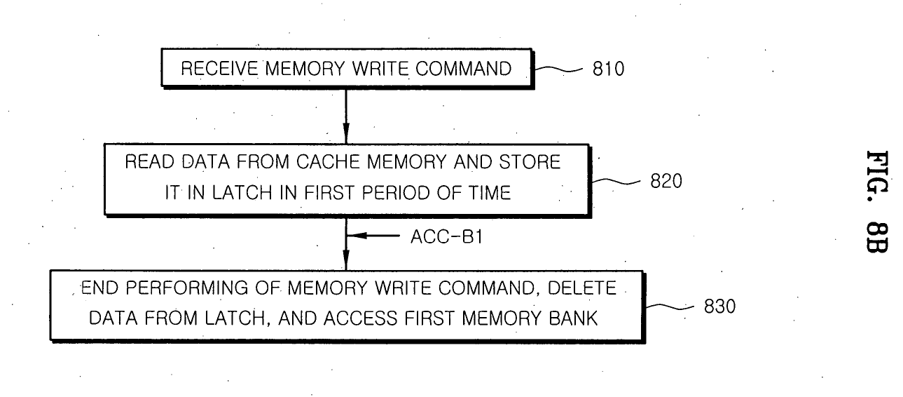

FIGS. 8A and 8B are conceptual diagrams illustrating the operation of one embodiment of a semiconductor device when a memory write command WB1 and a memory access command ACC-B1 are simultaneously performed on the same memory bank.

While receiving the memory write command WB1 (step 810) and controlling data to be read from cache memory 270 and stored in latch 250-1 via second data bus 210-2 in a first period of time T₁₁ (step 820), when controller 230 receives the memory access command ACC_B1 that accesses first memory bank 2201, controller 230 stops a memory write operation according to the memory write command WB1 and initializes (or discards) the data moved to latch 250-1 so as to perform the memory access command ACC_B1 (step 830).

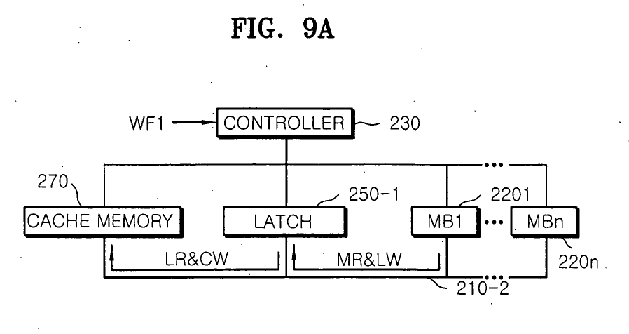

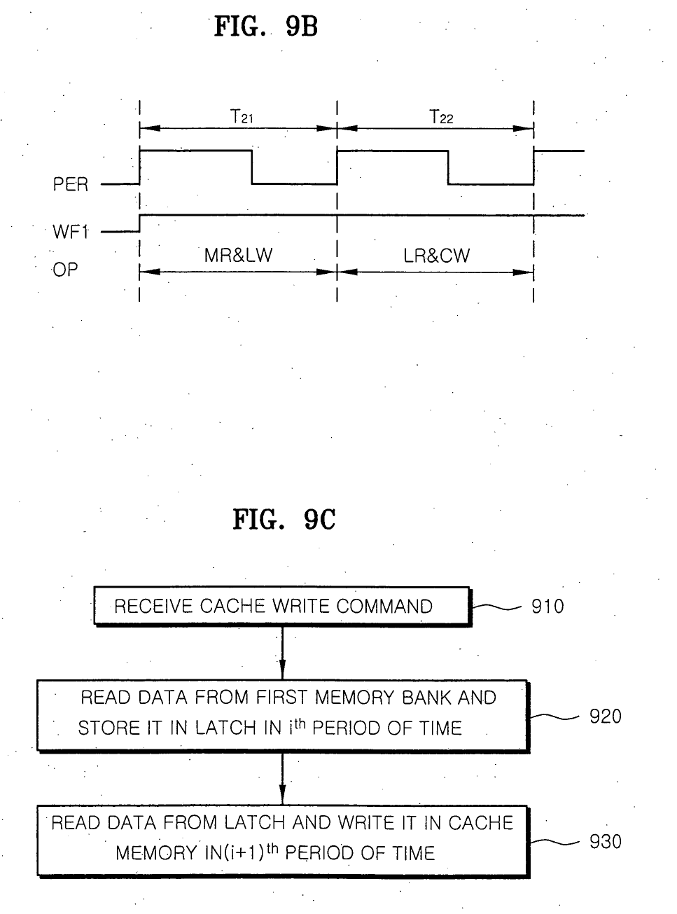

FIGS. 9A through 9C are conceptual diagrams illustrating a cache write command WF1 performed by one embodiment of a semiconductor device.

When receiving the cache (memory) write command WF1 that moves data stored in first memory bank 2201 to cache memory 270 so as to use the data in a subsequent memory access operation (step 910), controller 230 controls the data to be read from first memory bank 2201 (MR) and stored in latch 250-1 (LW) in an i^{th} period of time (i is a natural number) (step 920).

Next, in an (i+1)^{th} period of time T₂₂, controller 230 controls the data to be read from latch 250-1 (LR) and written to cache memory 270 (CW) (step 930).

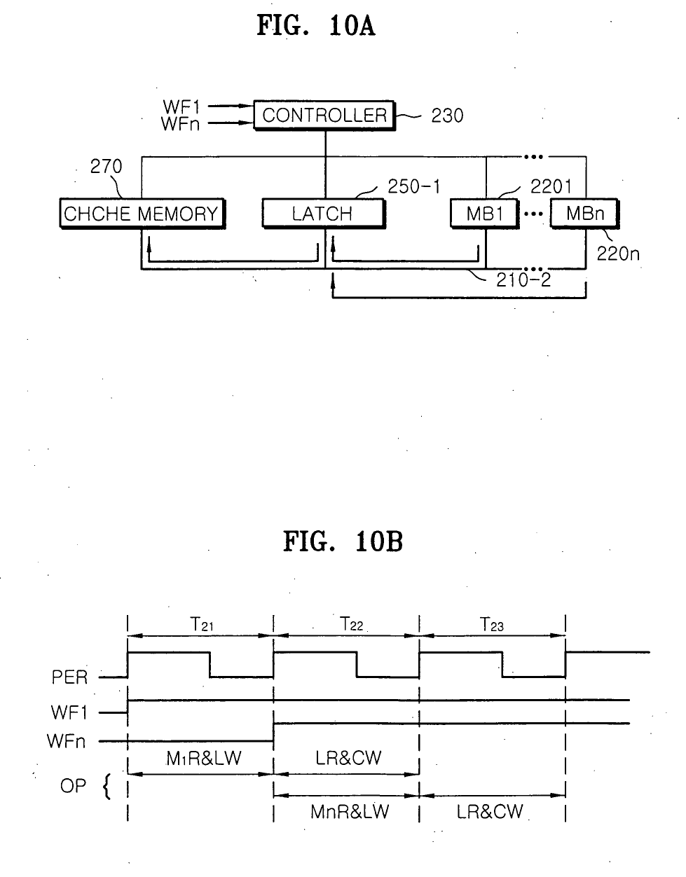

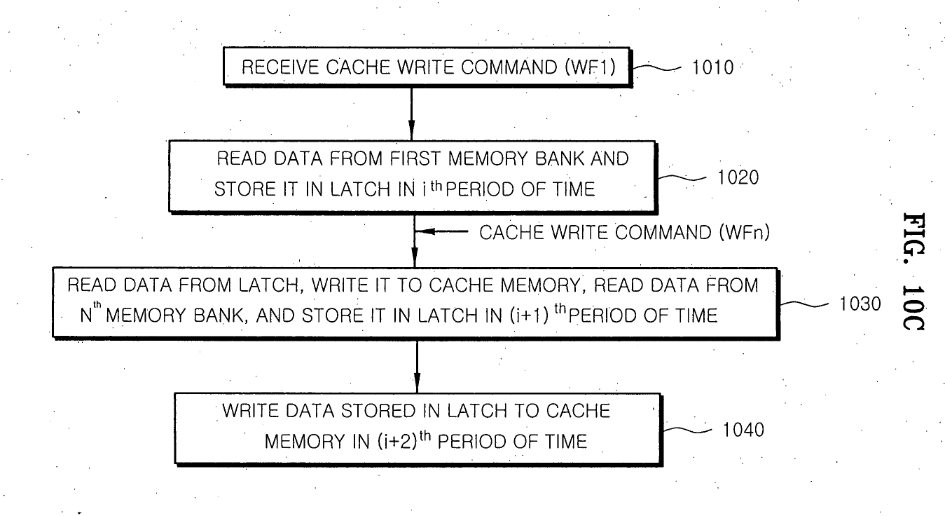

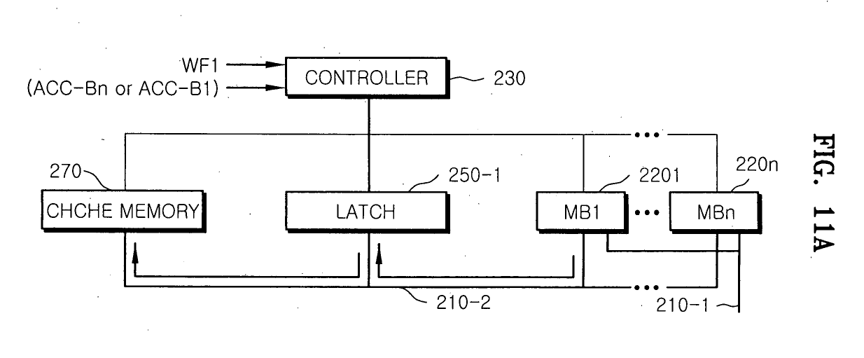

FIGS. 10A through 10C are conceptual diagrams illustrating cache write commands WF1 and WFn, which are sequentially generated, which are performed by one embodiment of a semiconductor device.

Upon sequentially receiving the cache write commands WF1 and WFn (step 1010), controller 230 controls data to be read from first memory bank 2201 (MR) and stored in the latch 250-1 via second data bus 210-2 (LW) in an i^{th} period of time T₂, (step 1020).

Next, in an (i+1)^{th} period of time T₂₂, controller 230 controls the data to be read from latch 250-1 (LR) and written to cache memory 270 via second data bus 210-2 (CW), and at the same time, controls data to be read from n^{th} memory bank 220n and stored in latch 250-1 via second data bus 210-2 (LW) (step 1030).

Next, in an (i+2)^{th} period of time T₂₃, controller 230 controls the data to be read from latch 250-1 (LR) and written to cache memory 270 (CW) via second data bus 210-2 (step 1040).

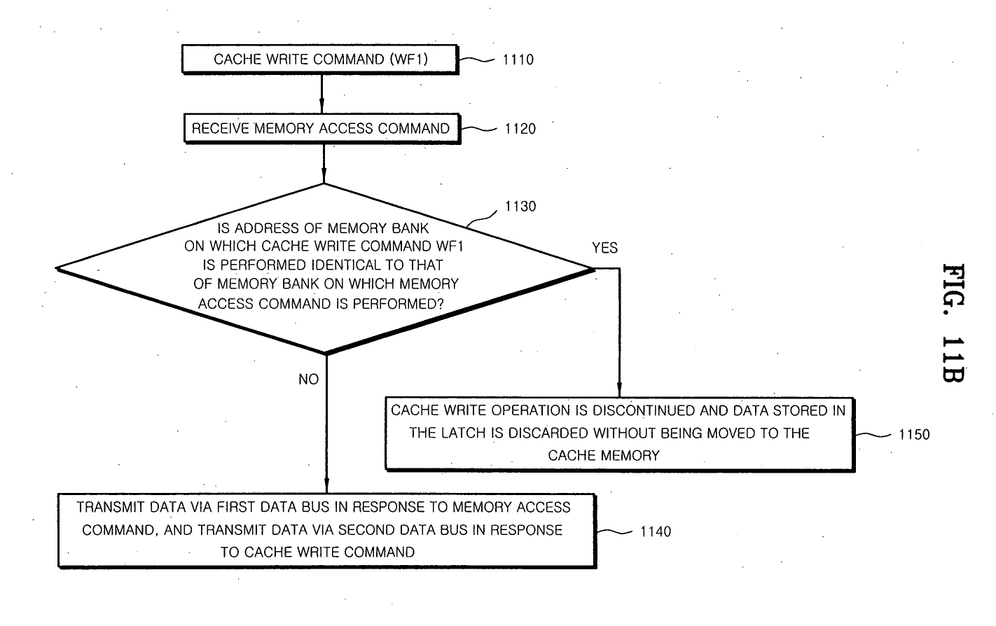

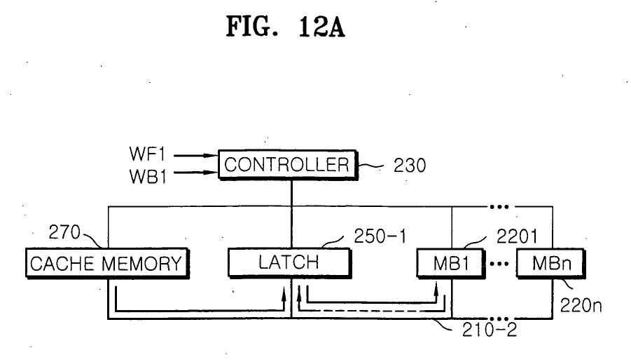

FIGS. 11A and 11B are conceptual diagrams illustrating the operation of one embodiment of a semiconductor device when a cache write command WF1 and a memory access command ACC_Bn or ACC_B1 are simultaneously performed.

When receiving the memory access command ACC_Bn or ACC_B1 during a cache write operation in response to the cache write command WF1 (steps 1110 and 1120), controller 230 determines whether an address of a memory bank on which the cache write command WF1 is performed is identical to that of a memory bank on which the memory access command ACC_Bn or ACC_B1 is performed (step 1130).

If the address of the memory bank 2201 on which the cache write command WF1 is performed is different from that of a memory bank 220n on which the memory access command ACC_Bn is performed, data according to the memory access command ACC_Bn is transmitted via first data bus 210-1 and data according to the cache write command WF1 is transmitted via second data bus 210-2 (step 1140). Here, the memory access command ACC_Bn is a command that accesses the n^{th} memory bank.

That is, data to be input from or output to a corresponding memory bank in response to the memory access command is input or output via first data bus 210-1, and at the same time, data to be input from or output to a corresponding memory bank in response to the cache write command is input or output via second data bus 210-2.

However, if the address of memory bank 2201 on which the cache write command WF1 is performed is identical to that of memory bank 2201 on which the memory access command ACC_B1 is performed, a cache write operation in response to the cache write command WF1 is discontinued and data stored in latch 250-1 is discarded without being moved to cache memory 270 (step 1150).

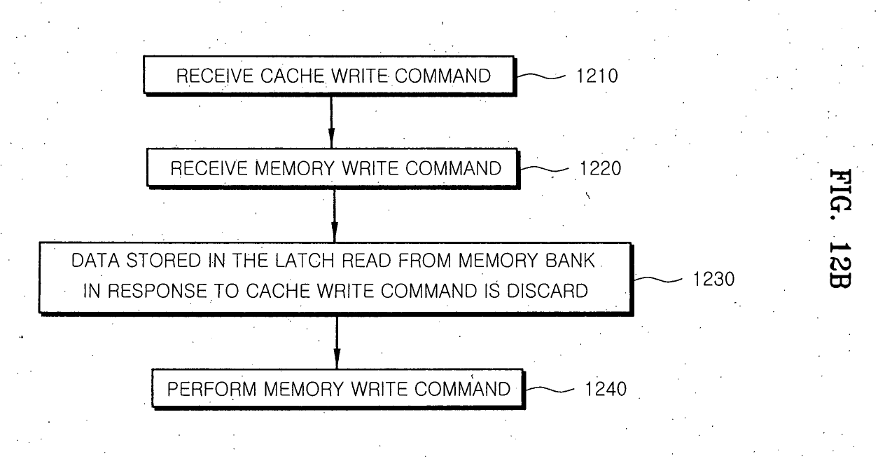

FIGS. 12A and 12B are conceptual diagrams illustrating the operation of one embodiment of a semiconductor memory when a memory write command WB1 is generated after a cache write command WF1.

While performing a cache write operation in response to the cache write command WF1 (step 1210), when the memory write command WB1 is applied to controller 230 (step 1220), controller 230 initializes data that is read from first memory bank 2201 and stored in latch 250-1 in response to the cache write command WF1 (step 1230).

Since a memory write operation is to initialize data stored in cache memory 270 and store new data in cache memory 270, when the memory write command WB1 is applied to controller 230 during the cache write operation according to the cache write command WF1, the cache write operation is not required any further, and thus, the data stored in latch 250-1 is initialized or deleted.

Thereafter, controller 230 performs a memory write operation as described with reference to FIGS. 5A through 5C, in response to the memory write command WB1 (step 1240).

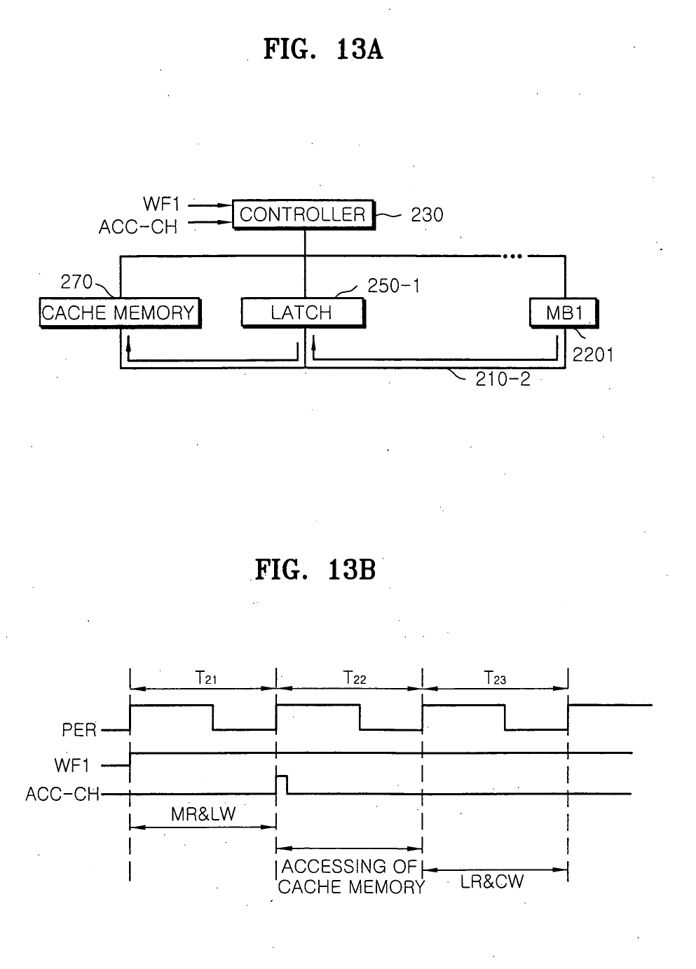

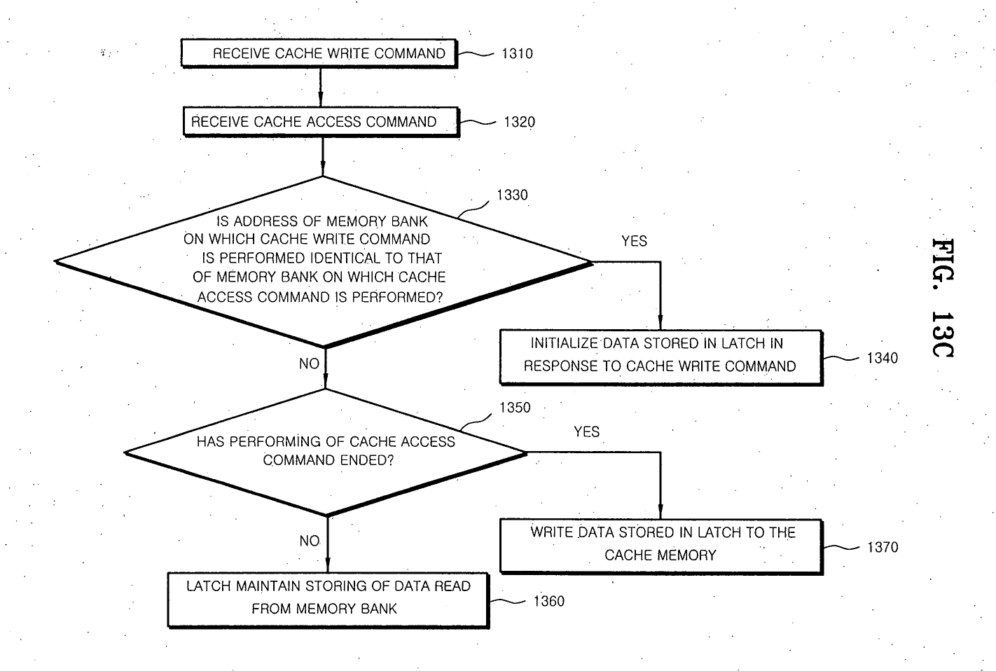

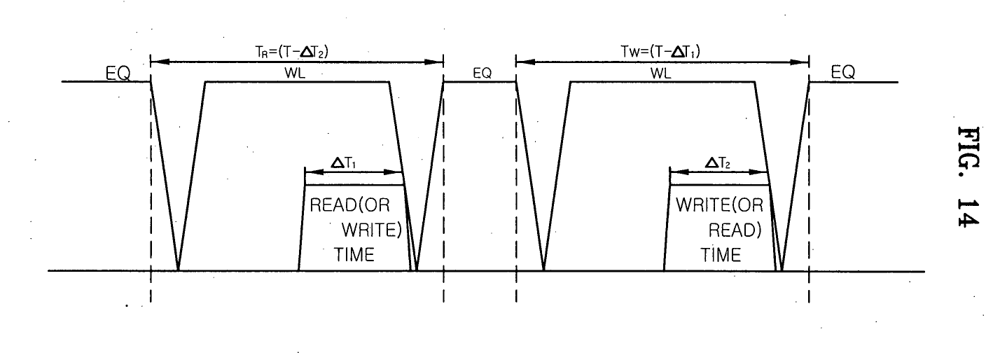

FIGS. 13A through 13C are conceptual diagrams illustrating the operation of a semiconductor device when a cache write command WF1 and a cache access command ACC_CH are simultaneously performed, according to an embodiment of the present invention.

While controlling a cache write operation in response to a cache write command WF1 (step 1310), when controller 230 receives the cache access command ACC_CH (step 1320), controller 230 determines whether the address of a memory bank on which the cache write command WF1 is performed is identical to that of a memory bank on which the cache access command ACC_CH is performed (step 1330).

If the address of memory bank 2201 (that of data stored in the latch 250-1) on which the cache write command WF1 is performed is identical to that of cache memory 270 on which the cache access command ACC_CH is to be performed, latch 250-1 initializes the data stored therein in response to the cache write command WF1 (step 1340).

Otherwise, controller 230 determines whether the cache access command ACC_CH is completed (step 1350).

When the cache access command ACC_CH is completed, controller 230 controls the data stored in the latch 250-1 to be written to cache memory 270 via second data bus 210-2 (step 1370). However, when the cache access command ACC_CH is not completed, latch 250-1 retains the data stored therein (step 1360). A cache refresh operation in response to a cache refresh command, and a memory access operation in response to a memory access command have priorities over a memory write operation or a cache write operation.

FIG. 14 is a timing diagram of an operating time of a semiconductor device such as that shown in FIGS. 2, 3, and 4. Referring to FIG. 14, data is read from a corresponding memory bank (or a cache memory) and written to latch 250-1 in an i^{th} period of time T_{R}, and the data is read from latch 250-1 and stored in cache memory or a corresponding memory bank in an (i+1)^{th} period of time T_{w}.

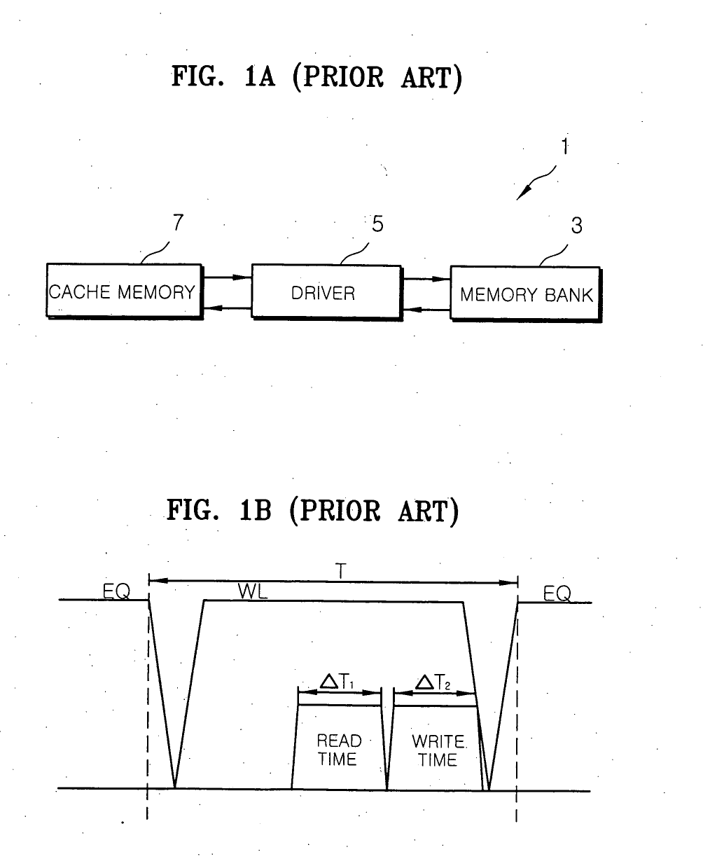

The i^{th} period of time T_{R} is shorter by the amount of a write time ΔT₂ than the period of time T shown in FIG. 1, and the (i+1)^{th} period of time T_{w} is shorter by the amount of a read time ΔT₁ than the period of time T. The amount of the read time ΔT₁ may be equal to or different from that of the write time ΔT₂. Accordingly, a semiconductor device and a method of transmitting data as described above are capable of reducing a delay in an operating time between a cache memory and a memory bank.

As described above, it is possible to reduce a delay in an operating time between a cache memory and a memory bank, thereby improving the performance of a system with the semiconductor device.

While this invention has been particularly shown and described with reference to exemplary embodiments thereof, it will be understood by those skilled in the art that various changes in form and details may be made therein without departing from the scope of the invention as defined by the appended claims.

What is claimed is:

1. A semiconductor device, comprising:
a memory bank having a plurality of memory cells;
a first data bus which is connected to the memory bank and via which data to be input to, or output from, the memory bank is transmitted in response to a memory access command which accesses the memory bank;
a second data bus connected to the memory bank;
a cache memory connected to the second data bus; and
a latch connected to the second data bus.

2. The semiconductor device of claim 1, wherein the second data bus is adapted to transmit first data from the cache memory to the latch in an i^{th} period of time, and to transmit the first data from the latch to the memory bank in an (i+1)^{th} period of time, in response to a memory write command which writes the first data stored in the cache memory to the memory bank, where i is a natural number.

3. The semiconductor device of claim 1, wherein the second data bus is adapted to transmit first data from the memory bank to the latch in an i^{th} period of time, and to transmit the first data from the latch to the cache memory in an (i+1)^{th} period of time, in response to a cache write command which writes the first data stored in the memory bank to the cache memory, where i is a natural number.

4. A semiconductor memory device, comprising:
a plurality of memory banks, each memory bank including a plurality of memory cells;
a cache memory having a plurality of cache memory cells;
a latch adapted to store data read from either one of the plurality of the memory banks or data read from the cache memory; and
a data bus connected to each of the plurality of memory banks, to the cache memory, and to the latch.

5. The semiconductor device of claim 4, further comprising a controller adapted to control data read from one of the cache memory and a corresponding one of the memory banks to be stored in the latch, in a first period of time, and further adapted to control the data read from the latch to be stored in the other of the cache memory and the corresponding one of the memory banks, in a second period of time, in response to a write command.

6. The semiconductor device of claim 4, further comprising a controller adapted to control the data read from the cache memory to be stored in the latch in an i^{th} period of time, and further adapted to control the data read from the latch to be stored in a corresponding first one of the memory banks in an (i+1)^{th} period of time, in response to a memory write command which moves the data stored in the cache memory to the first one of the memory banks, where i is a natural number.

7. The semiconductor device of claim 6, wherein when each memory cell of the cache memory is a DRAM cell, and wherein the controller is adapted to control the cache memory to refresh each DRAM cell only in the (i+1)^{th} period of time in response to a cache refresh command which refreshes each memory cell, where the cache refresh command is generated after the memory write command.

8. The semiconductor device of claim 6, wherein the controller is adapted to control the cache memory to retain the data stored therein until the memory write command is completed.

9. The semiconductor device of claim 6, wherein when receiving a memory access command which accesses the first memory bank after generation of the memory write command, the controller is adapted to control the memory write command to be discontinued and the data stored in the latch to be initialized.

10. The semiconductor device of claim 4, further comprising a controller adapted to control data read from a first memory bank of the memory banks to be stored in the latch in an i^{th} period of time, and the data read from the latch to be stored in the cache memory in an (i+1)^{th} period of time, in response to a cache write command which moves data stored in the first memory bank to the cache memory, where i is a natural number.

11. The semiconductor device of claim 10, further comprising an external data bus connected to each of the memory banks,
wherein the controller is adapted to control data which is to be input to or output from a corresponding second one of the plurality of the memory banks to be transmitted via the external data bus, in response to a memory access command which accesses to the second memory bank, where the memory access command is generated after the cache write command.

12. The semiconductor device of claim 10, wherein when receiving a command which accesses the first memory bank after generation of the cache write command, the controller is adapted to control the data stored in the latch to be initialized.

13. The semiconductor device of claim 10, wherein when a memory write command which moves the data stored in the cache memory to the first memory bank is generated after the cache write command, the controller is adapted to control the cache write command to be discontinued, the data stored in the latch to be initialized, the data read from the cache memory to be stored in the latch in an n^{th} period of time, and the data read from the latch to be stored in the first memory bank in an (n+1)^{th} period of time, n being a natural number.

14. The semiconductor device of claim 10, wherein a cache access command which accesses the cache memory is generated after the cache write command, the controller writes the data stored in the latch to the cache memory after the cache access command is completed.

15. A semiconductor device comprising:
a plurality of memory banks, each memory bank including a plurality of memory cells;
a cache memory having a plurality of cache memory cells;
a first latch adapted to store first data read from a corresponding one of the memory banks so as to write the first data to the cache memory in a cache write operation;
a second latch adapted to store second data read from the cache memory so as to write the second data to a corresponding one of the memory banks in a memory write operation; and
a data bus connected to each memory bank, to the cache memory, and tp the first and second latches.

16. The semiconductor device of claim 15, wherein during the cache write operation, the first data read from the corresponding one of the memory banks is stored in the first latch via the data bus in an i^{th} period of time, and the first data read from the latch is stored in the cache memory via the data bus in an (i+1)^{th} period of time, where i is a natural number.

17. The semiconductor device of claim 15, wherein during the memory write operation, the second data read from the cache memory is stored in the second latch via the data bus in an i^{th} period of time, and the second data read from the second latch is stored in the corresponding one of the memory banks via the data bus in an (i+1)^{th} period of time, where i is a natural number.

18. A method of transmitting data, comprising:
receiving a memory write command which writes data stored in a cache memory to a memory bank; and
in response to the memory write command, reading the data from the cache memory via a data bus connected to the cache memory and storing the read data to a latch connected to the data bus in an i^{th} period of time, and reading the data from the latch and writing the read data in the memory bank connected to the data bus in an (i+1)^{th} period of time, where i is a natural number.

19. The method of claim 18, further comprising, when the cache memory includes a plurality of dynamic random access memory (DRAM) cells:
receiving a cache refresh command which refreshes each DRAM cell, the cache refresh command being generated after the memory write command; and
delaying refreshing of each DRAM cell in the i^{th} period of time, and refreshing each dynamic random access memory cell only in the (i+1)^{th} period of time.

20. The method of claim 18, further comprising:
determining whether the memory write command is completed; and
retaining the data stored in the cache memory until the memory write command is completed, and initializing the data stored in the cache memory after the memory write command is completed.

21. The method of claim 18, further comprising:
determining whether an external access command which accesses the memory bank is generated; and
discontinuing the memory write command when the external access command is generated, and initializing the data stored in the latch.

22. A method of transmitting data, comprising:
receiving a cache write command which moves data stored in a corresponding first memory bank of a plurality of memory banks to a cache memory;
in response to the cache write command,
reading the data from the first memory bank via a data bus connected to the first memory bank and storing the read data in a latch connected to the data bus in an i^{th} period of time, where i is a natural number, and
reading the data from the latch via the data bus and storing the read data in the cache memory connected to the data bus in an (i+1)^{th} period of time.

23. The method of claim 22, further comprising:
receiving a memory access command which accesses a corresponding second one of the memory banks, the memory access command being generated after the cache write command; and
transmitting data to be input, to or output from, the second memory bank via an external data bus connected to each memory bank.

24. The method of claim 22, further comprising:
receiving a memory write command which writes data to the first memory bank, the memory write command being generated after the cache write command; and
in response to the memory write command, when an address of the data stored in the latch is identical to that of the data to be written to the first memory bank, initializing the data stored in the latch without writing the data to the cache memory.

25. The method of claim 22, further comprising:
receiving a cache access command which accesses the cache memory, the cache access command being generated after the cache write command; and
when data is input to, or output from, the cache memory based on the cache access command, writing the data to the cache memory after the inputting or outputting of the data.

26. The method of claim 22, further comprising:
receiving a cache write command which writes set data to the cache memory, the cache write command being generated after the cache write command; and
when an address of the data stored in the latch is identical to that of the data to be written to the first memory bank in response to the memory write command, initializing the data stored in the latch without writing the data to the cache memory.

27. A method of transmitting data, comprising:
receiving a cache write command which moves first data stored in a corresponding first memory bank of a plurality of memory banks to a cache memory;
in response to the cache write command, reading the first data from the first memory bank and storing the read first data in a latch in an i^{th} period of time, where i is a natural number;
receiving a memory write command which moves second data stored in the cache memory to a corresponding second one of the memory banks;
initializing the first data stored in the latch;
in response to the memory write command,
reading the second data from the cache memory and storing the read second data in the latch in an n^{th} period of time, and
reading the second data from the latch and writing the read second data in the second memory bank in an (n+1)^{th} period of time.

28. A method of transmitting data, comprising:
receiving a data transmission command; and
in response to the data transmission command, transmitting data stored in a first data storage device to a latch via a data bus in an i^{th} period of time, and transmitting the data stored in the latch to a second data storage device via the data bus in an (i+1)^{th} period of time, where i is a natural number.

29. The method of claim 28, wherein the first data storage device is a memory bank, and the second data storage device is a cache memory.

30. The method of claim 28, wherein the first data storage device is a cache memory, and the second storage device is a memory bank.
